(19) United States
(12) Patent Application Publication
(10) Pub. No.: US 2023/0024316 A1
(43) Pub. Date: Jan. 26, 2023

(54) Environmentally Friendly Aircraft

(71) Applicant: EMBRAER S.A., Sao Jose dos Campos-SP (BR)

(72) Inventors: Raphael Felipe Gama RIBEIRO, São José dos Campos (BR); Luis Gustavo TRAPP, São Paulo (BR); Luis Carlos AFFONSO, São José dos Campos (BR)

(21) Appl. No.: 17/864,974

(22) Filed: Jul. 14, 2022

Related U.S. Application Data
(60) Provisional application No. 63/223,417, filed on Jul. 19, 2021.

(51) Int. Cl. F02C 9/40; B64D 37/30; B64D 37/04

(52) U.S. Cl. CPC F02C 9/40; B64D 37/30; B64D 37/04; F05D 2220/323; F05D 2270/08

(57) ABSTRACT

An aircraft stores cryogenic fuel in one or more fuel tanks inside the aircraft fuselage or at other appropriate positions on the aircraft, and stores non-cryogenic fuel in plural standard jet fuel tanks e.g., inside the aircraft wings. A controller controls selective routing of non-cryogenic fuel or cryogenic (e.g., hydrogen) fuel to dual fuel engines. In one operating mode, the dual fuel engines normally use the cryogenic hydrogen fuel as the main fuel, and reserve the non-cryogenic fuel for application to the dual fuel engines only on an exception basis, thereby providing cleaner and more environmentally friendly operation.

### CROSS-REFERENCE TO RELATED APPLICATION

Priority is claimed from Provisional Application No. 63/223,417 filed Jul. 19, 2021, incorporated herein by reference in its entirety and for all purposes.

### FIELD

The example technology herein relates to aircraft design, and more particularly to aircraft operations, aircraft performance, aircraft fuel systems, and aircraft propulsion systems. Still more particularly, the example technology herein relates to aircraft designs for using alternative, environmentally friendly fuels such as hydrogen.

### BACKGROUND & SUMMARY

The aviation industry is searching for alternatives to decrease the environmental footprint of its products. One goal is to operate commercial aircraft in a way that provides no or only very low greenhouse gas emissions. Among the several potential options, hydrogen-based propulsion is one of the most promising for regional and narrow body aircraft.

Hydrogen provides advantages as an aviation fuel, such as high heating value (specific energy or energy to mass ratio) and specific heat (resulting in potentially greater engine efficiency). Additionally, its combustion does not produce carbon-based gases, which addresses the referenced environmental challenge. However, some important challenges arise from hydrogen usage: it has a very low energy density (energy to volume ratio), so it must be stored compressed or cryogenically liquified in order to decrease the installation burden, in terms of weight and drag, on the aircraft. Additionally, hydrogen tanks are heavy, and currently hydrogen cost per energy content is 3-4 times higher than the cost of standard fossil-based Jet Fuel. Therefore, different approaches must be taken in order to balance hydrogen benefits with its downsides.

Aircraft should be sized taking into account mission fuel reserves, which are important to provide contingency plans for pilots, if the destination airport is not able to authorize the landing of the aircraft and an alternate must be sought. Typically, reserves are translated to a diversion mission, with a fixed distance (100-200 nmi) plus loiter time (30-45 minutes). In the vast majority of the missions, the reserve fuel is not used.

For short range regional aircraft, the typical sector energy requirement is of similar order of magnitude to the reserve sector. Therefore, if hydrogen tanks were to be sized considering the typical mission plus reserves, they would have twice the volume and weight of hydrogen tanks sized only for the main mission. Given this fact, a strategy that minimizes the need of carrying hydrogen in case the aircraft needs to alternate to the very infrequent sector, is of interest.

In addition to the challenges discussed above, hydrogen production and infrastructure are also important points that need to be addressed. Hydrogen may be produced by different means, but in order to have net (“well to wake”) emissions reductions, so-called “blue” or “green” hydrogen should be employed. Hydrogen is commonly produced from natural gas with a process of steam methane reforming, where natural gas is mixed with very hot steam and a catalyst. The result is H₂ and a CO₂ byproduct. Unfortunately, producing one part hydrogen causes a release of nine parts of CO₂. If the CO₂ byproduct is released to the atmosphere, the hydrogen produced is sometimes called “grey hydrogen”. “Blue” hydrogen may be produced the same way but the CO₂ byproduct is stored and contained or sold, instead of being released into the atmosphere. Hydrogen can also be produced by electrolysis of water, which produces O₂ and H₂ but no CO₂ byproduct. When the electricity used to power electrolysis comes from renewable sources like wind, water or solar, the resulting hydrogen gas is said to be “green.” Producing green hydrogen is currently much more expensive than producing blue hydrogen (because renewable sources of electricity are more expensive), but costs of green hydrogen are projected to come down substantially in the future. It is very likely that the blue/green hydrogen infrastructure will be built gradually in the future. See e.g., “Questions and answers: A Hydrogen Strategy for a climate neutral Europe”, (European Commission 8 Jul. 2020 Brussels)

An aircraft that runs only on hydrogen will only be able to fly routes where both airports of the flight terminus city pair have hydrogen refueling stations. Or alternatively, it will need hydrogen tanks large enough to carry hydrogen to use on the return flight, rendering its economic viability even more challenging. This lack of infrastructure risks retarding the adoption of hydrogen until it is available in the majority of airports.

Moreover, the hydrogen infrastructure will probably develop unevenly around the world. Specifically, more developed countries will likely be able to invest greater sums in economical, environmentally-friendly hydrogen production infrastructure as compared with underdeveloped countries. Therefore, an aircraft that is only able to operate with hydrogen as a fuel will not be able to operate globally after its certification and entry into service, which is an additional drawback to its economic feasibility.

Another challenge that needs to be addressed is the delivery process of a hydrogen aircraft, from its manufacturing plant to its operational hubs. An aircraft manufactured in a location A must have enough hydrogen refueling stations en route to reach its operating hub B. This may be a major challenge since a hydrogen aircraft will likely have smaller ranges than its fossil-based counterparts.

Finally, it is worth pointing out that although hydrogen combustion does not produce CO2, it does emit other potentially greenhouse gases, such as water vapor, contrails (condensation trails) and NOx. Contrails are human-made clouds. They form in air above about 25,000 feet, when that air is moist and colder than −40 degrees Celsius. Like regular clouds, they arise when water vapor, in this case from the engine exhausts, forms into droplets by condensing onto particles in the air. Within a second, the water droplets freeze to make tiny ice crystals that show up visually as contrails. Some claim contrails contribute to global warming. See e.g., Pearce, “How Airplane Contrails Are Helping Make the Planet Warmer” Yale School of the Environment (Jul. 18, 2019).

Engine technologies such as combustion chamber optimization will likely be able to minimize NOx, and the impact of water vapor/contrails is greatly minimized if flight altitudes below a certain threshold (25-30 kft) are used. These lower flight altitudes are more compatible with regional aircraft, so this aircraft category may be the best fit for hydrogen propulsion, at least in the shorter term.

Arguably, aircraft with higher payload range capabilities may not be able to use Fuel Cell systems since they typically are much heavier than gas turbines. In the last decades, a number of system concepts have been attempted in order to support the use of hydrogen in Gas Turbines. However, further improvements are possible and desirable.

### BRIEF DESCRIPTION OF THE DRAWINGS

FIG. 1 is an example non-limiting schematic diagram of an aircraft propulsion and fuel system.

FIG. 1A shows an example turboprop aircraft including both cryogenic and non-cryogenic fuel tanks.

FIG. 2 shows an example system operation concept for a short, typical range mission.

FIG. 3 shows an example system operation concept for an extended range mission.

FIG. 4 shows an example system operation concept for pure SAF/Jet Fuel missions.

FIG. 5 shows an example system concept operation for a contrail avoidance strategy.

FIG. 6 shows an example system operation concept for a design range mission.

FIG. 7 is a flowchart of example program control steps performed by a fuel controller.

### DETAILED DESCRIPTION OF NON-LIMITING EMBODIMENTS

Example Non-Limiting Embodiments Provide the following combinations of features:

An aircraft that has dual fuel engines, where one of the fuels consumed is a non-cryogenic (liquid at ambient temperature) fuel (Jet Fuel, Jet A, Jet A-1, Jet B, SAF, Avgas, Ethanol, etc.) and another fuel consumed is a cryogenic fuel such as liquid hydrogen or methane. In one embodiment, the cryogenic fuel could be fossil-based or non-fossil based but preferably comprises hydrogen. At temperatures typically encountered on board an aircraft, the cryogenic fuel is in the gaseous state which ordinarily would require large, heavy, high pressure storage vessels capable of withstanding 5000-10,000 psi. Such tanks may be too heavy and bulky for many or most aircraft. Therefore, in one embodiment, the cryogenic fuel is cooled to a liquid state before being loaded onto the aircraft so it can be stored compactly at low pressure.

For example, storage of hydrogen as a liquid requires cryogenic temperatures because the boiling point of hydrogen at one atmosphere pressure is −252.8° C. Similarly, the boiling point of methane is −161.6° C. But if these fuels can be maintained at such cryogenic temperatures, they can be stored in low pressure, lighter weight vessels when compared to high pressure gaseous hydrogen tanks.

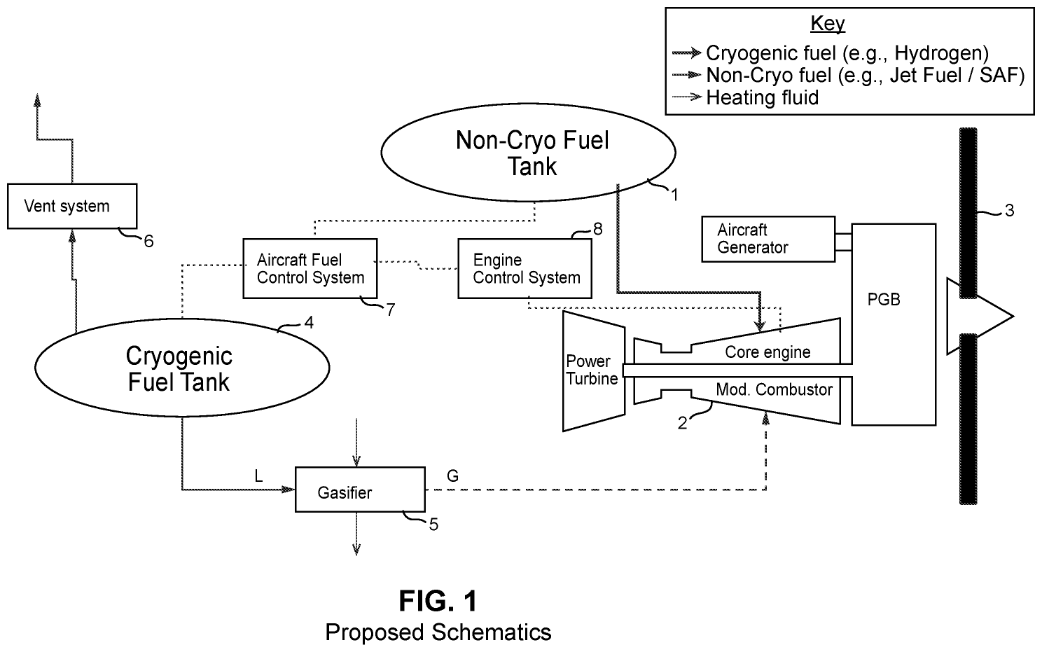

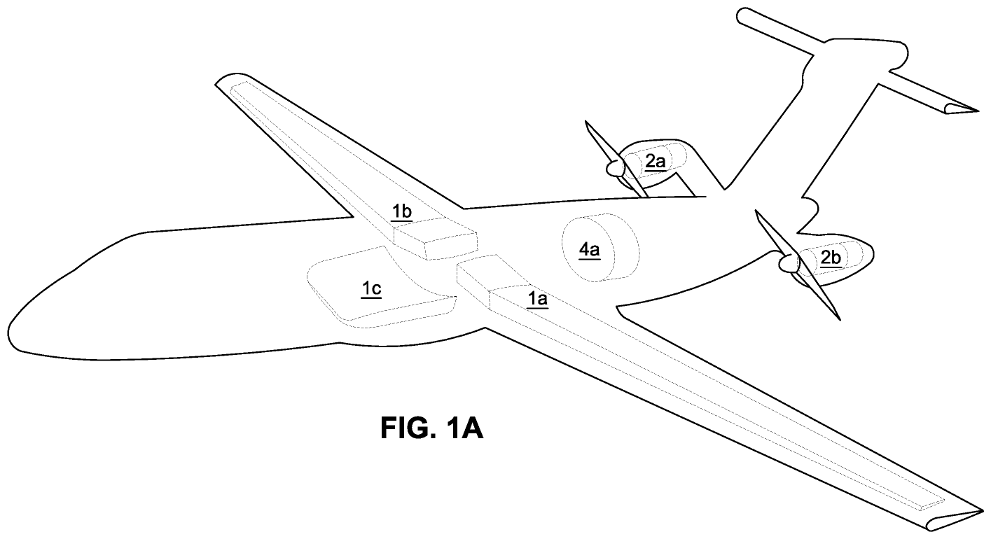

The cryogenic fuel is stored in one or more tanks inside the aircraft fuselage or at other appropriate positions (e.g. wing pods), and the non-cryogenic fuel is stored in two or more fuel tanks, located in standard positions, usually inside the left and right aircraft wings. See FIG. 1a. In one embodiment, the cryogenic fuel is the main fuel that will normally be used for propelling the aircraft through the air, while the non-cryogenic fuel is a reserve or range extending fuel, which will be used only in special cases for propelling the aircraft through the air, including but not limited to:
Reserve fuel, part of regulatory requirements to allow the aircraft to alternate to another airport destination.
Reserve fuel in case of failure of a cryogenic fuel system component during flight, or to allow dispatching of the aircraft when the failure is identified on the ground.
Reserve fuel for the next flight leg, in case the origin airport does not have a cryogenic fuel supply.
Reserve fuel in case using non-cryogenic fuel in specific environmental or operational conditions increases aircraft safety.
Contrails minimization, when using cryogenic fuel at certain atmospheric conditions leads to unwanted contrail formation.
Range extending fuel, increasing the aircraft range when compared to a single cryogenic fuel aircraft.
Supplementary fuel in critical flight cases, in order to increase safety during special environmental conditions (e.g. rain and hail), emergency flight conditions and/or to minimize the effects of hidden failures.

In one embodiment, the cryogenic fuel can be employed as the reserve fuel, extending the range of the aircraft when it is certain that successive destinations will not be able to resupply the aircraft with hydrogen, as will occur while the hydrogen infrastructure is being progressively expanded across the globe.

The non-cryogenic and cryogenic fuels can be used independently or in conjunction to provide energy for the engine.

The non-cryogenic fuel may be used as a motive fuel (e.g. engine variable inlet guide vanes actuation) or cooling fuel (e.g. engine and/or electric generator and/or electric motor oil cooler) at all flight phases, even when the cryogenic fuel is the only fuel being consumed by the engines. propelling the aircraft.

The cryogenic fuel can be used to cool or keep the non-cryogenic fuel temperatures down in order to reduce fuel vapors flammability inside the non-cryogenic fuel tank. The non-cryogenic fuel can be used to heat the cryogenic fuel before it enters the engines.

The control of the fuel mix is performed preferentially by the aircraft, considering, but not limited to:
Amount of fuel in all tanks.
Type of fuels (e.g. SAF or Jet Fuel) being carried.
Environmental flight conditions (aiming to increase safety during rain and hail conditions, or minimize the formation of contrails, etc.).
Environmental objectives in each flight phase.
Component failures (including failure conditions where one engine is fed by the non-cryogenic fuel and the other by the cryogenic fuel).
Economic conditions (such as the relative cost of each fuel or CO2 compensation schemes).
Fuel availability at the destination.

### Expected Benefits of Example Embodiments

1) A lighter and more economical aircraft is obtained, when compared to an aircraft that is able to operate only with hydrogen:
Smaller and lighter hydrogen tanks: hydrogen fuel is sized for the typical mission, resulting in much smaller and lighter tanks than if they were to be sized for the design long range mission plus reserves. A smaller hydrogen tank may have a better form factor and increase its weight efficiency (gravimetric index).
Smaller and lighter hydrogen tanks present lower volume requirements, decreasing the aircraft required additional structures to support the tanks and associated wetted areas. This translates to decreased Operating Empty Weight and Drag, which results in smaller manufacturing and operating costs and environmental impacts.
Better aircraft weight and balance, since wing tanks are kept in the design and are closer to the aircraft center of gravity than the hydrogen tanks.

2) Reduced environmental footprint aircraft:
Aircraft will be able to optimize fuel usage to create less emissions, in terms of CO2, NOx, contrails and water vapor.
System allows earlier hydrogen fueled aircraft adoption while the supply infrastructure is not fully developed, enabling a faster and more widespread utilization of such aircraft.
Flexibility of selecting the most appropriate fuel capable of minimizing aircraft environmental footprint at any atmospheric condition.

3) Increased operational flexibility for aircraft:
Operators are provided with a new degree of freedom to optimize their businesses and operating networks, by trading off fuel availability, CO2 reduction, payload, range, and fuel costs at each specific route.
Operation in a much broader network is enabled, when compared to a pure hydrogen aircraft, given its fuel flexibility.
Aircraft ferry range operations (delivery or travel to maintenance centers) is facilitated since the aircraft may be refueled at practically all airports on the globe.
Aircraft second or third operating life in developing countries, where the Hydrogen infrastructure may take much longer to be implemented, is enabled.

4) Potential aircraft safety increase
Capability of using a traditional fuel (Jet Fuel or SAF) during critical conditions, such as Go-around, rain & hail, take-off and approach and landing, may decrease operational risks, especially at the early adoption phase.
Redundant fuel sources and storage increases safety. It may allow for a single tank architecture for either SAF/Jet Fuel or hydrogen, or other fuel system architecture simplifications.

Example Non-Limiting More Detailed Description of an Aircraft

A schematic layout of an example embodiment aircraft is shown in FIG. 1, and FIG. 1a shows an example aircraft including cryogenic and non-cryogenic fuel tanks. Main components are listed from 1 to 8. A core engine (2), comprising a compressor, combustion chamber and a turbine (mechanically coupled to the compressor), is defined as the engine core. The engine core (2) provides torque to drive the propulsor (3), which provides propulsive thrust to the aircraft (FIG. 1a). A variety of core engine arrangements may be considered, including two or more shaft architectures, often found in gas turbine engines. In some embodiments, the referred propulsor (3) may be a Propeller (ducted or unducted, single plane or multi-planes, co-rotating or contrarotating) or a Fan. Thus, in one embodiment, the engine core (2) and propulsor (3) may together comprise a turboprop (see FIG. 1A). There may be plural turboprops on the same aircraft, each of which have dual (or more) fuel engine cores. In one embodiment or operating mode, one turboprop on the aircraft could consume cryogenic fuel while another turboprop on the aircraft could consume non-cryogenic fuel, or in another embodiment or operating mode both turboprops could consume cryogenic fuel, or in another embodiment or operating mode both turboprops could consume non-cryogenic fuel.

In one embodiment, the core engine (2) is modified or specifically designed to be able to operate with non-cryogenic fuels such as Jet A, Jet A-1, Jet B, SAF, etc. and cryogenic fuels in gaseous or liquid forms (e.g., hydrogen or methane). The consumption of each fuel type may be concurrent or independent, depending on the mixing fuel strategy of each mission.

Here, we use the term “non-cryogenic fuel” to refer to a fuel that is naturally in the liquid state when stored at typical aircraft environment temperatures and reasonable pressures (e.g., 1 atmosphere); and we use the term “cryogenic fuel” to refer to a fuel that requires storage at extremely low (cryogenic) temperatures in order to maintain it in a liquid state. Cryogenic temperatures are typically considered to be temperatures below −150 degrees centigrade. Hydrogen is an example of a cryogenic fuel because at ambient sea-level pressures such as 1 atmosphere it becomes a liquid only at cryogenic temperatures such as below −250 degrees centigrade. Conventional jet fuel (aviation turbine fuel or ATF) is an example of a non-cryogenic fuel because it is a liquid at typical ambient temperatures and pressures an aircraft encounters during fueling, taxiing and operation. See e.g., DEF STAN 91-91 and ASTM specification D1655. Common jet fuel freezes at around −40 to −53 degrees Centigrade depending on type, and has a boiling point that is about 176 degrees Centigrade, It is thus in the liquid state at all typical ambient temperatures a typical commercial jet aircraft encounters.

As FIG. 1a shows, the non-cryogenic fuel tanks (1) are installed on the aircraft wings or fuselage, and the cryogenic fuel tanks (4) (storing majorly either gaseous or liquid hydrogen) may be installed on the aircraft fuselage or in other aircraft locations, such as on wing pods (if present) or the like. Typically, one cryogenic fuel tank and one non-cryogenic fuel tank are responsible for (alternately or together) feeding one engine, however aircraft safety assessment considerations may allow tank sharing between engines. The wing non-cryogenic fuel can be used as motive flow (e.g. engine variable inlet guide vanes actuation) and for engine oil cooling, returning to the tank without being used, even when the fuel being consumed is the cryogenic fuel. This minimizes the changes in engine hardware and/or technology to perform the motive and cooling functions, reducing risks and investments needed to develop and certify a cryogenic or dual-fuel aviation engines. Thus, in one embodiment, the fuel controller (2) controls the system so that non-cryogenic fuel continues to be used in a conventional fashion to provide motive flow and/or engine oil cooling of the core engine, while the core engine burns cryogenic fuel to propel the aircraft. This approach in one embodiment allows the non-cryogenic fuel to be held in reserve while continuing to use that non-cryogenic fuel for important long proven secondary uses that do not use up, consume or exhaust the non-cryogenic fuel.

Additionally, the cryogenic fuel lines that feed the engines may be directed through the non-cryogenic fuel tanks in order to keep the non-cryogenic fuel temperature within acceptable flammability limits for its fuel vapors and eliminating or minimizing the need of a tank inertization system, saving aircraft weight and further improving fuel savings and minimizing emissions. Thus, the introduction of cryogenic fuel to the system permits the cryogenic fuel to be used to replace prior non-cryogenic fuel cooling systems that might otherwise be necessary, reducing the costs of safely maintaining non-cryogenic fuel on board the aircraft.

As FIG. 1 further shows, in addition to the core engine (2) modifications and the cryogenic fuel tanks (4) installation, new systems are introduced: A gasifier system (5) which is responsible for conditioning the cryogenic fuel to be fed to the core engine combustor (2) (i.e., converting the cryogenic liquid fuel to a gas), and a venting system (6), which is responsible for maintaining the cryogenic fuel tanks' internal pressure within safe limits as the cryogenic fuel boils off due to heat from the airplane environment. See e.g., Winnefeld et al, “Modelling and Designing Cryogenic Hydrogen Tanks for Future Aircraft Applications,” Energies 11, 105 (2018) doi:10.3390/en11010105. The venting system (6) for example may be designed to monitor temperature and pressure of the cryogenic fuel tanks and provide controlled venting of those tanks to the atmosphere in order to avoid excessive pressure building up within the tanks as the cryogenic fuel they contain boils off. The cryogenic fuel tanks (1) would typically be designed with sufficient thermal insulation to avoid excessive boil off, and would be recharged with cryogenic fuel at cryogenic temperature each time the aircraft is refueled after landing.

An Aircraft fuel control system (7) is responsible to operate and optimize fuel source mixing strategies at any flight phase, enabling different mixing strategies objectives, as outlined in the provided mission profiles and in the Protection Focus Section below. The aircraft fuel control system (7) is also responsible to set the fuel source mixing strategy in exceptional conditions, like aircraft or engine component failures (in-flight or to allow dispatch with failed components), adverse weather conditions (e.g., Rain and hail), etc.; or in conditions demanded by the engine (e.g., In-flight starting, in sub-idle conditions, when detecting operability issues, etc.). The fuel mixing strategy may involve both engines consuming the same fuel or even a first engine consuming the non-cryogenic fuel and a second engine consuming the cryogenic fuel. An engine control system (8) is responsible for implementing the aircraft fuel control system-defined fuel mixing strategy in the most suitable manner in terms of engine steady state and transient performance and operability characteristics, as well as accommodating failures. Some functions of the Aircraft Fuel Control System may be embedded in the Engine Control System if bringing benefits in terms of robustness, safety or cost.

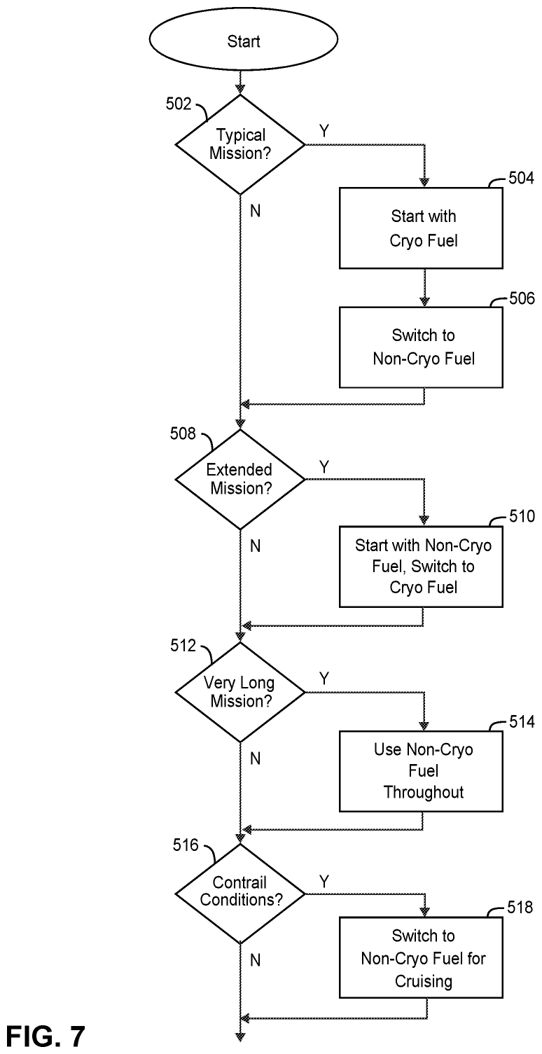

Each of these control systems (7), (8) may be implemented by a combination of hardware and software, for example one or more controllers or systems on chips (SOCs) connected to data buses and executing software instructions shown in FIG. 7 that are stored in non-transitory memory such as programmable semiconductor FLASH memory. The control system (7) produces output signals that enables the control system to control valves to selectively open and close, thereby selectively routing cryogenic fuel or standard non-cryogenic fuel to the dual or multi fuel engine(s). In one embodiment, a fuel mixing apparatus may be employed to mix the standard non-cryogenic fuel and the cryogenic fuel (in desired, controllable mixing ratios) such that the dual fuel engine (3) may burn a mixture of standard non-cryogenic fuel and cryogenic fuel.

The proposed environmentally friendly aircraft architecture allows a more fuel efficient aircraft, provides fuel flexibility for the aircraft operator, allowing it to use a fuel(s) that has/have lower environmental impact, letting the operator adopt an environmentally friendly aircraft before the cryogenic refueling infrastructure is fully available at its route network. It also allows the operator to choose between Jet Fuel, SAF or hydrogen based on mission requirements (range, payload), airport fuel availability and fuel costs. Among the possible fuel mixing possibilities, a few are briefly discussed below:

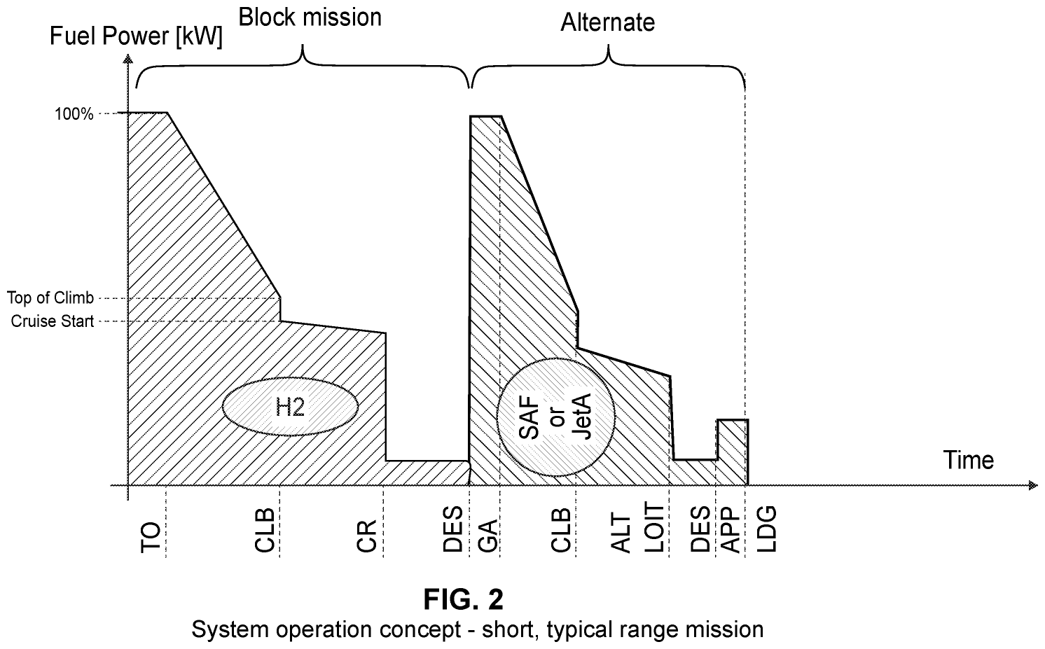

Typical range mission (FIG. 2): Regional aircraft have much shorter typical operating ranges than their design missions (e.g. Turboprops typical missions 200-300 nmi, Jets 400-600 nmi, while their design maximum ranges are from 2 to 5 times these distances). The typical missions cover around 80% of the complete operating network. Therefore, a possible mixing strategy for the typical mission is presented in FIG. 2 which starts with cryogenic fuel and later switches to non-cryogenic fuel if necessary. This strategy maximizes CO2 reduction. In that instance, Go-around is performed with Jet Fuel/SAF which is otherwise kept in reserve and not burned unless necessary (see FIG. 7 blocks 502, 504, 506).

Additionally to the representation of FIG. 2, other mixing strategies may be considered in order to encompass missions where other factors play a role (wind, traffic, weather, etc), leading to a higher or lower block fuel than originally planned. This may involve, but is not limited to: carrying extra hydrogen (for either the main mission or to be used during Go-around), momentarily using Jet Fuel/SAF during flight (to account for unexpected consumption, to operate under rain or hail, etc.), shifting to Jet Fuel/SAF at final descent to perform the Go-around with Jet Fuel/SAF if needed. In-flight fuel shifting may be performed one engine at a time to increase the system overall reliability. Therefore, the aircraft fuel system control is capable of switching fuels for each engine individually during the flight. The mixing strategy for conditions like these may depend on specific design features of the dual fuel engines that will be installed on the environmentally friendly aircraft. In one example embodiment shown, TO, CLB, CR, DE, APP and LDG phases of “normal” or expected flight are executed using cryogenic fuel, and additional, extra or in some cases unexpected flight phases such as additional CLB, GA, ALT, LOIT, additional DES flight phases are performed using non-cryogenic fuel, where these phases of flight are defined as follows:

| | |
|---|---|
| TO | Takeoff |
| CLB | Climb |
| CR | Cruise |
| DES | Descent |
| GA | Go Around |
| ALT | Alternate Route |
| LOIT | Loiter |
| APP | Approach |
| LDG | Landing or Landing Roll |

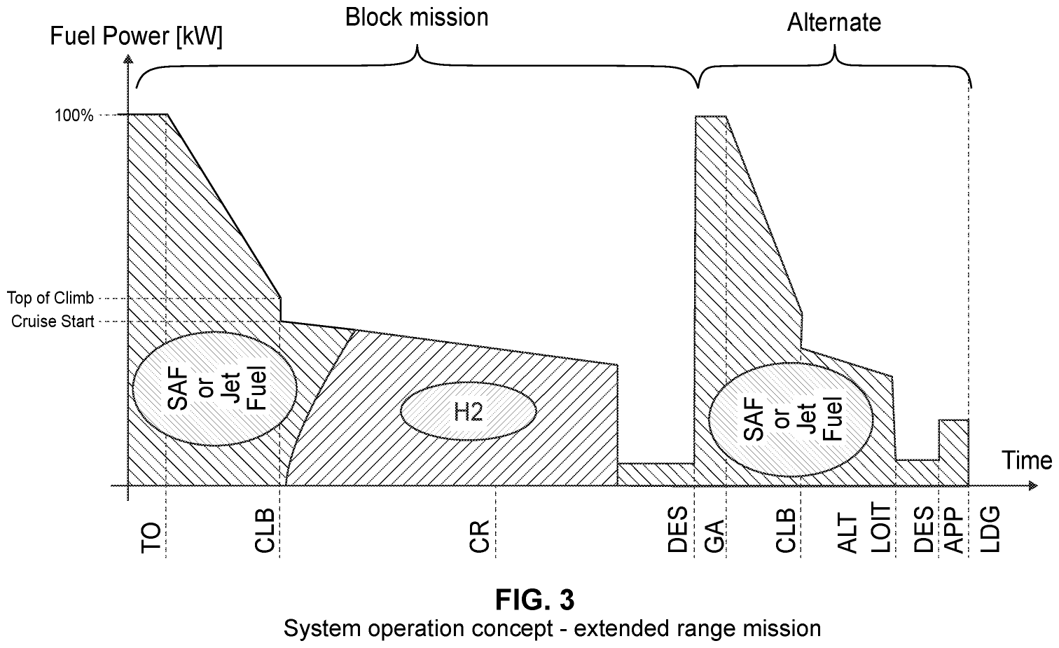

Extended range mission (FIG. 3): Around 20% of regional aircraft operations involve mission ranges above the typical sectors. Although a smaller percentage of the missions, these missions are important to enable a profitable operating network, since these smaller aircraft may connect airports of greater distances with smaller demands. For these longer-range missions, a mixing strategy that uses Jet Fuel/SAF to enable a range extension may be employed. In this case, because the non-cryogenic fuel heating value is lower than that of hydrogen, it is more efficient from the aircraft weight standpoint to use the non-cryogenic fuel in the beginning of the mission, reducing the aircraft weight faster in the beginning of the flight, leaving the consumption of the hydrogen closer to the destination. See FIG. 7, blocks 508, 510.

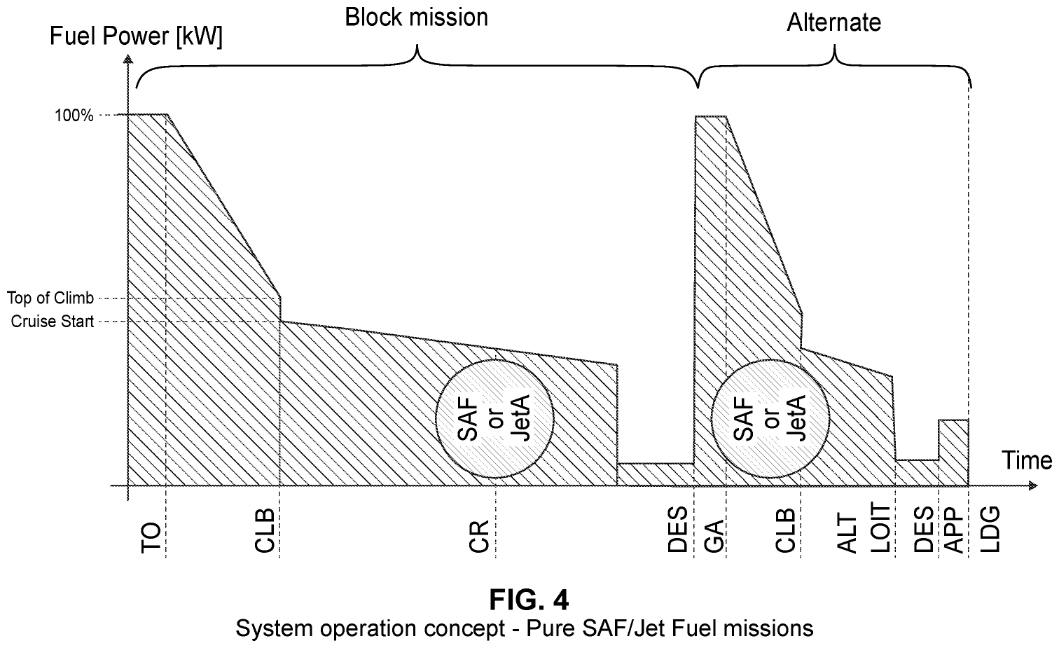

Pure SAF/Jet Fuel missions (FIG. 4): If the aircraft needs to perform its maximum range missions at low payloads (for example, moving to a maintenance location—ferry range with zero payload), or if it is operating in an airport which does not have hydrogen available, it may utilize the full capabilities of its SAF/Jet Fuel tanks and operate with its hydrogen tanks at minimum level or empty (see FIG. 7, blocks 512, 514). For delivery purposes, this mission profile can also be used, or the cryogenic fuel tanks can be filled with hydrogen as reserve fuel, even if hydrogen is not available along the delivery route, since hydrogen is not expected to be needed during the delivery flight. This strategy reduces the aircraft weight (given the higher heating value of hydrogen), decreasing emissions.

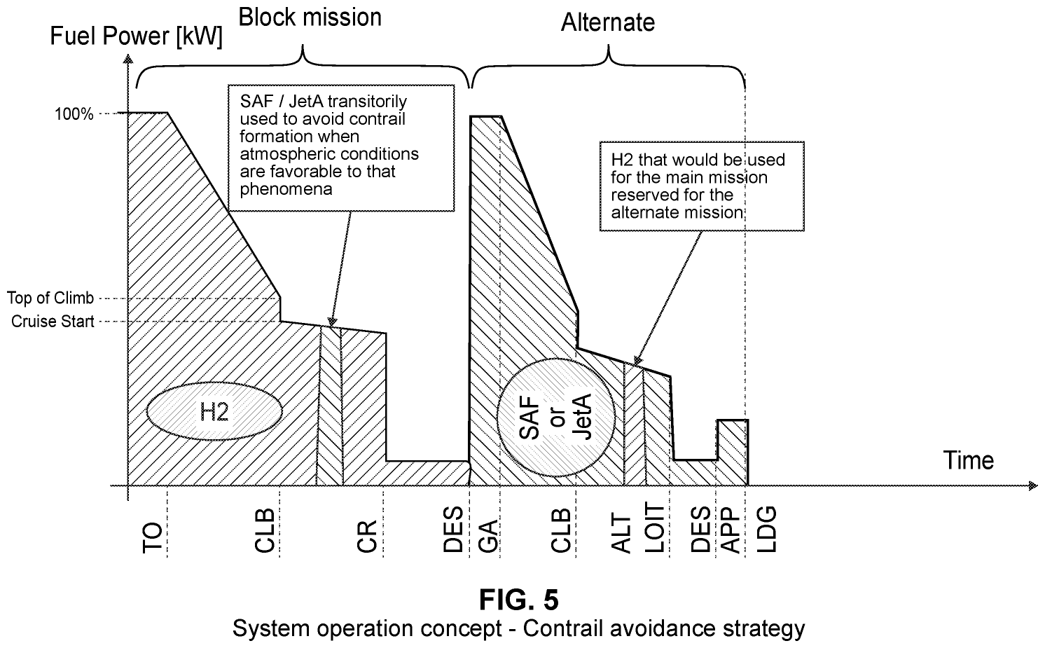

Contrails avoidance strategy (FIG. 5): at specific atmospheric conditions (temperature, humidity), contrails may be formed from the exhaust plumes of gas turbines. Hydrogen combustion produces higher amounts of water vapor than Jet Fuel or SAF, which can mean leaving larger and more visible contrails. The dual fuel strategy can be useful if the aircraft encounters the referred atmospheric conditions during its main mission phase, since the Jet Fuel/SAF originally provisioned for the range extension or the alternate mission can be transitorily used to minimize contrails (FIG. 7, blocks 516, 518) while the aircraft tries to change to a different flight altitude where the contrails-favorable conditions are not present. An example of such utilization is provided in FIG. 5.

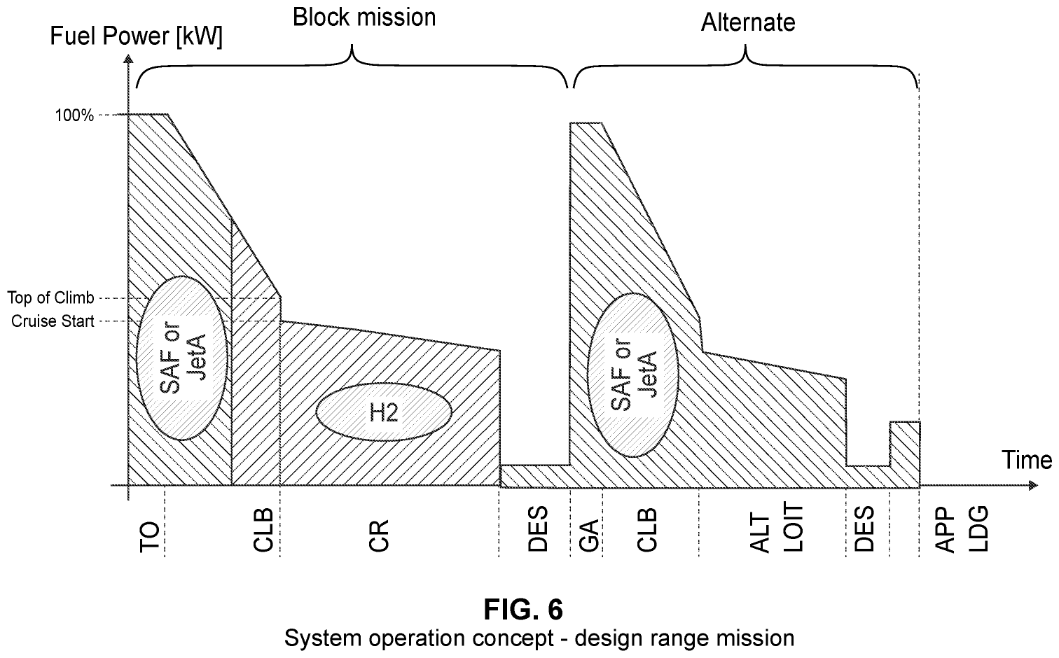

Design range mission (FIG. 6): Used to size the hydrogen tanks maximum volumetric capacity.

All patents and publications cited above are incorporated herein by reference.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An aircraft comprising:
dual fuel engines, wherein one of the fuels is a non-cryogenic fuel and the other fuel is a cryogenic fuel;
one or more cryogenic fuel tanks inside the aircraft fuselage or at other appropriate positions on the aircraft;
plural non-cryogenic fuel tanks inside the aircraft wings; and
a controller that controls fuel flow from the fuel tanks to the dual fuel engines, the controller being configured so that the cryogenic fuel is the main fuel that will normally be used by the dual fuel engines, while the non-cryogenic fuel is a reserve or range extending fuel, which the controller provides to the dual fuel engines only on an exception basis.

2. The aircraft of claim 1 wherein the exception basis comprises:
reserve fuel, part of regulatory requirements to allow the aircraft to alternate to another airport;
reserve fuel in case of failure of a cryogenic fuel system component during flight, or to allow dispatching of the aircraft when the failure is identified on the ground;
reserve fuel for the next flight leg, in case the origin airport does not have a cryogenic fuel supply;
reserve fuel in case using non-cryogenic fuel in specific environmental or operational conditions increase aircraft safety;
contrails minimization, when using cryogenic fuel at certain atmospheric conditions lead to unwanted contrail formation;
range extending fuel, increasing the aircraft range when compared to a single cryogenic fuel aircraft; and
supplementary fuel in critical flight cases, in order to increase safety during special environmental conditions, emergency flight conditions and/or to minimize the effects of hidden failures.

3. The aircraft of claim 1 wherein the controller employs the cryogenic fuel as the reserve fuel, extending the range of the aircraft when it is certain that successive destinations will not be able to resupply the aircraft with hydrogen, as will occur while the hydrogen infrastructure is being progressively expanded across the globe.

4. The aircraft of claim 1 wherein the controller uses the non-cryogenic and cryogenic fuels independently or in conjunction to provide energy for the engine.

5. The aircraft of claim 1 wherein the aircraft is further configured to use the non-cryogenic fuel as a motive or cooling fluid at all flight phases, even when the cryogenic fuel is the only fuel being consumed.

6. The aircraft of claim 1 wherein the aircraft is further configured to use the cryogenic fuel to cool or keep the non-cryogenic fuel temperatures down in order to reduce fuel vapors flammability inside the non-cryogenic fuel tank.

7. The aircraft of claim 1 wherein the aircraft is configured to use the non-cryogenic fuel to heat the cryogenic fuel before the cryogenic fuel enters the engines.

8. The aircraft of claim 1 wherein the controller is configured to control the fuel mix based on factors including:
amount of fuel in all tanks,
type of fuels being carried,
environmental flight conditions,
environmental objectives in each flight phase,
component failures,
economic conditions, and
fuel availability at the destination.

9. The aircraft of claim 1 wherein the aircraft fuel system control is configured to switch fuels for each engine individually during the flight.

10. A method of operating an aircraft comprising:
storing cryogenic fuel in one or more cryogenic fuel tanks inside the aircraft fuselage or at other appropriate positions on the aircraft;
storing non-cryogenic fuel in plural non-cryogenic fuel tanks inside the aircraft wings; and
selectively routing non-cryogenic fuel or cryogenic fuel to dual fuel engines, including the dual fuel engines normally using the cryogenic fuel as the main fuel, and reserving the non-cryogenic fuel for application to the dual fuel engines only on an exception basis.

11. The method of claim 10 wherein the exception basis comprises:
reserve fuel, part of regulatory requirements to allow the aircraft to alternate to another airport;
reserve fuel in case of failure of a cryogenic fuel system component during flight, or to allow dispatching of the aircraft when the failure is identified on the ground;
reserve fuel for the next flight leg, in case the origin airport does not have a cryogenic fuel supply;
reserve fuel in case using non-cryogenic fuel in specific environmental or operational conditions increase aircraft safety;
contrails minimization, when using cryogenic fuel at certain atmospheric conditions lead to unwanted contrail formation;
range extending fuel, increasing the aircraft range when compared to a single cryogenic fuel aircraft; and
supplementary fuel in critical flight cases, in order to increase safety during special environmental conditions, emergency flight conditions and/or to minimize the effects of hidden failures.

12. The method of claim 10 further including employing the cryogenic fuel as the reserve fuel, extending the range of the aircraft when it is certain that successive destinations will not be able to resupply the aircraft with hydrogen, as will occur while the hydrogen infrastructure is being progressively expanded across the globe.

13. The method of claim 10 further including using the non-cryogenic and cryogenic fuels independently or in conjunction to provide energy for the engines.

14. The method of claim 10 further including using the non-cryogenic fuel as a motive or cooling fluid at all flight phases, even when the cryogenic fuel is the only fuel being consumed.

15. The method of claim 10 further including using the cryogenic fuel to cool or keep the non-cryogenic fuel temperatures down in order to reduce fuel vapors flammability inside the non-cryogenic fuel tank.

16. The method of claim 10 further including using the non-cryogenic fuel to heat the cryogenic fuel before it enters the engines.

17. The method of claim 10 further including switching fuels for each engine individually

18. The method of claim 10 further including controlling mixing of non-cryogenic fuel and cryogenic fuel based on factors including:
amount of fuel in all tanks,
type of fuels being carried,
environmental flight conditions,
environmental objectives in each flight phase,
component failures,
economic conditions, and
fuel availability at the destination.

19. An aircraft comprising:
a first fuel tank for storing cryogenic fuel,
a second fuel tank for storing non-cryogenic fuel,
an engine coupled to a propulsor, and
a controller configured to supply the engine with cryogenic fuel from the first fuel tank to consume and burn while controlling non-cryogenic fuel from the second fuel tank to cool engine components and/or provide motive flow to the propulsor while the engine consumes and burns the cryogenic fuel.

20. The aircraft of claim 19 wherein the cryogenic fuel comprises hydrogen and the non-cryogenic fuel comprises fossil fuel or Sustainable Aviation Fuels

21. The aircraft of claim 20 with at least two engines which can be set to each consume the same fuel or different fuels, depending on aircraft systems availability, reliability, failures or health.
